(19) United States
(12) Patent Application Publication
(10) Pub. No.: US 2024/0388609 A1
(43) Pub. Date: Nov. 21, 2024

(54) ENHANCED PRIVATE ACCESS NETWORK INFORMATION HEADER FOR INTERNET PROTOCOL MULTIMEDIA SUBSYSTEM VOICE OVER INTERNET ACCESS

(71) Applicant: QUALCOOMM Incorporated, San Diego, CA (US)

(72) Inventors: Prashanth MOHAN, Chennai (IN); Sridhar BHARADWAJ, Bengaluru (IN); Vinay Kumar SINGH, Lucknow (IN)

(21) Appl. No.: 18/317,626

(22) Filed: May 15, 2023

(51) Int. Cl. H04L 65/1073; H04L 65/1016; H04L 65/1104; H04W 60/04

(52) U.S. Cl. CPC H04L 65/1073; H04L 65/1016; H04L 65/1104; H04W 60/04

(57) ABSTRACT

Various aspects of the present disclosure generally relate to wireless communication. In some aspects, a user equipment (UE) may transmit, via an access network, a session initiation protocol (SIP) registration message for internet protocol (IP) multimedia subsystem (IMS) registration, the SIP registration message including a private access network information (PANI) header that includes at least one of an access point name (APN) field indicating an APN associated with the access network or an access speed field indicating a data rate associated with the access network. The UE may access one or more IMS services via the access network based at least in part on the SIP registration message. Numerous other aspects are described.

### FIELD OF THE DISCLOSURE

Aspects of the present disclosure generally relate to wireless communication and to techniques and apparatuses for an enhanced private access network information (PANI) header internet protocol multimedia subsystem (IMS) voice over internet access.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured to transmit, via an access network, a session initiation protocol (SIP) registration message for internet protocol (IP) multimedia subsystem (IMS) registration, the SIP registration message including a private access network information (PANI) header that includes at least one of an access point name (APN) field indicating an APN associated with the access network or an access speed field indicating a data rate associated with the access network. The one or more processors may be configured to access one or more IMS services via the access network based at least in part on the SIP registration message.

Some aspects described herein relate to an IMS device for wireless communication. The IMS device may include one or more memories and one or more processors coupled to the one or more memories. The one or more processors may be configured to receive an SIP registration message for IMS registration associated with a UE, the SIP registration message including a PANI header that includes at least one of an APN field indicating an APN associated with an access network or an access speed field indicating a data rate associated with the access network. The one or more processors may be configured to enable one or more IMS services for the UE via the access network based at least in part on the SIP registration message.

Some aspects described herein relate to a method of wireless communication performed by a UE. The method may include transmitting, via an access network, an SIP registration message for IMS registration, the SIP registration message including a PANI header that includes at least one of an APN field indicating an APN associated with the access network or an access speed field indicating a data rate associated with the access network. The method may include accessing one or more IMS services via the access network based at least in part on the SIP registration message.

Some aspects described herein relate to a method of wireless communication performed by an IMS device. The method may include receiving an SIP registration message for IMS registration associated with a UE, the SIP registration message including a PANI header that includes at least one of an APN field indicating an APN associated with an access network or an access speed field indicating a data rate associated with the access network. The method may include enabling one or more IMS services for the UE via the access network based at least in part on the SIP registration message.

Some aspects described herein relate to a non-transitory computer-readable medium that stores a set of instructions for wireless communication by a UE. The set of instructions, when executed by one or more processors of the UE, may cause the UE to transmit, via an access network, an SIP registration message for IMS registration, the SIP registration message including a PANI header that includes at least one of an APN field indicating an APN associated with the access network or an access speed field indicating a data rate associated with the access network. The set of instructions, when executed by one or more processors of the UE, may cause the UE to access one or more IMS services via the access network based at least in part on the SIP registration message.

Some aspects described herein relate to a non-transitory computer-readable medium that stores a set of instructions for wireless communication by an IMS device. The set of instructions, when executed by one or more processors of the IMS device, may cause the IMS device to receive an SIP registration message for IMS registration associated with a UE, the SIP registration message including a PANI header that includes at least one of an APN field indicating an APN associated with an access network or an access speed field indicating a data rate associated with the access network. The set of instructions, when executed by one or more processors of the IMS device, may cause the IMS device to enable one or more IMS services for the UE via the access network based at least in part on the SIP registration message.

Some aspects described herein relate to an apparatus for wireless communication. The apparatus may include means for transmitting, via an access network, an SIP registration message for IMS registration, the SIP registration message including a PANI header that includes at least one of an APN field indicating an APN associated with the access network or an access speed field indicating a data rate associated with the access network. The apparatus may include means for accessing one or more IMS services via the access network based at least in part on the SIP registration message.

Some aspects described herein relate to an apparatus for wireless communication. The apparatus may include means for receiving an SIP registration message for IMS registration associated with a UE, the SIP registration message including a PANI header that includes at least one of an APN field indicating an APN associated with an access network or an access speed field indicating a data rate associated with the access network. The apparatus may include means for enabling one or more IMS services for the UE via the access network based at least in part on the SIP registration message.

Aspects generally include a method, apparatus, system, computer program product, non-transitory computer-readable medium, user equipment, base station, network entity, network node, wireless communication device, and/or processing system as substantially described herein with reference to and as illustrated by the drawings and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of internet protocol multimedia subsystem (IMS) communications, in accordance with the present disclosure.

FIG. 4 is a diagram illustrating an example associated with an enhanced private access network information (PANI) header for IMS voice over internet access, in accordance with the present disclosure.

FIG. 5 is a diagram illustrating an example process performed, for example, by a UE, in accordance with the present disclosure.

FIG. 6 is a diagram illustrating an example process performed, for example, by an IMS device, in accordance with the present disclosure.

FIGS. 7 and 8 are diagrams of example apparatuses for wireless communication, in accordance with the present disclosure.

### DETAILED DESCRIPTION

An internet protocol multimedia subsystem (IMS) architecture facilitates development and deployment of multiple types of multimedia services. Some considerations addressed by IMSs include interoperability, end-to-end service, and security. IMS has been positioned on top of network layers to make it access and device independent—that is, IMS services may be implemented on a variety of different end user devices, including mobile phones, personal computers, set top boxes, and/or modems, among other examples.

The IMS architecture allows carrier grade services to be offered on packet-switched networks. Examples of IMS services include IMS include Open Mobile Alliance (OMA) presence and group list management, Push-to-Talk over Cellular (PoC), Instant Messaging, TISPAN/3GPP multimedia telephony for IMS (MMTel), Voice over Long Term Evolution (LTE) (VoLTE), Video Telephony (VT), and Voice of Internet services, among other examples. A UE may access IMS services on various types of access networks. In some examples, a UE may access IMS services through 4G/LTE or 5G/New Radio (NR) IMS packet data network (PDN). For example, the LTE or NR IMS PDN may be an LTE or NR PDN operator by a same operator as the IMS. In some other examples, a UE may access IMS services via the Internet, such as via a Wi-Fi internet connection or a cellular internet connection (e.g., a cellular internet wireless local area network (CIWLAN)). For example, a UE may use an evolved packet data gateway (ePDG) tunnel to access IMS services over the Internet (e.g., via a Wi-fi internet connection or a cellular internet connection).

An IMS can support a variety of media types between two end points (e.g., between two UEs). IMS voice calls over internet (e.g., via Wi-fi internet or cellular internet) using an ePDG tunnel are gaining popularity due to improved coverage area and reduced costs. Session initiation protocol (SIP) is used for creating and control IMS multimedia sessions. In some examples, SIP messages over IMS may be populated with private access network information (PANI) headers to inform the IMS network about the access type and location details (e.g., a country code). In general, a UE includes the PANI header access type as 3GPP-EUTRAN-FDD/3GPP-NR-FDD when accessing IMS services through LTE/NR IMS PDNs. The PANI header access type for accessing IMS services through Wi-Fi internet is IEEE.802.11. However, when a UE accesses IMS services via a cellular internet access network (e.g., via CIWLAN technology), the PANI header access type is currently populated as IEEE.802.11 (e.g., the Wi-fi access type), which is incorrect as the connection is actually through an underling cellular internet connection. There is currently no access type present in the 3GPP specification that indicates the source of the internet connection as a 3G/4G/5G internet connection over which an ePDG tunnel can be established for voice access (and/or other IMS services). This may result in the IMS network offering services and or quality of service (QoS) levels that are associated with an incorrect type of access network.

Various aspects relate generally to a PANI header for IMS services. Some aspects more specifically relate to an enhanced PANI header for voice over internet access. In some examples, a UE may transmit, via an access network, an SIP registration message for IMS registration. The SIP registration message may include a PANI header that includes at least one of an access point name (APN) field or an access speed field. The APN field may indicate an APN associated with the access network. For example, the APN field may indicate an APN that identifies that the access network is a cellular internet access network. The access speed field may indicate a data rate of the access network (e.g., an average data rate experienced by the UE on the access network). The UE may access IMS services via the access network based at least in part on the SIP registration message. In some examples, when the access network is a cellular internet access network, the PANI header may include an access type field that is set to a cellular access type (e.g., 3GPP-EUTRA-FDD or 3GPP-NR-FDD), the APN field, and the access speed field.

Particular aspects of the subject matter described in this disclosure can be implemented to realize one or more of the following potential advantages. In some examples, by including, in the SIP registration message, the PANI header that includes the APN field and/or the access speed field, the describe techniques may be used to inform the IMS of the type of access network (e.g., including a type of internet access used for an internet access network) and/or an access speed of the access network. In this way, the IMS may enable services appropriate to the access network being used by the UE, such as services with QoS levels appropriate for the access network being used by the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

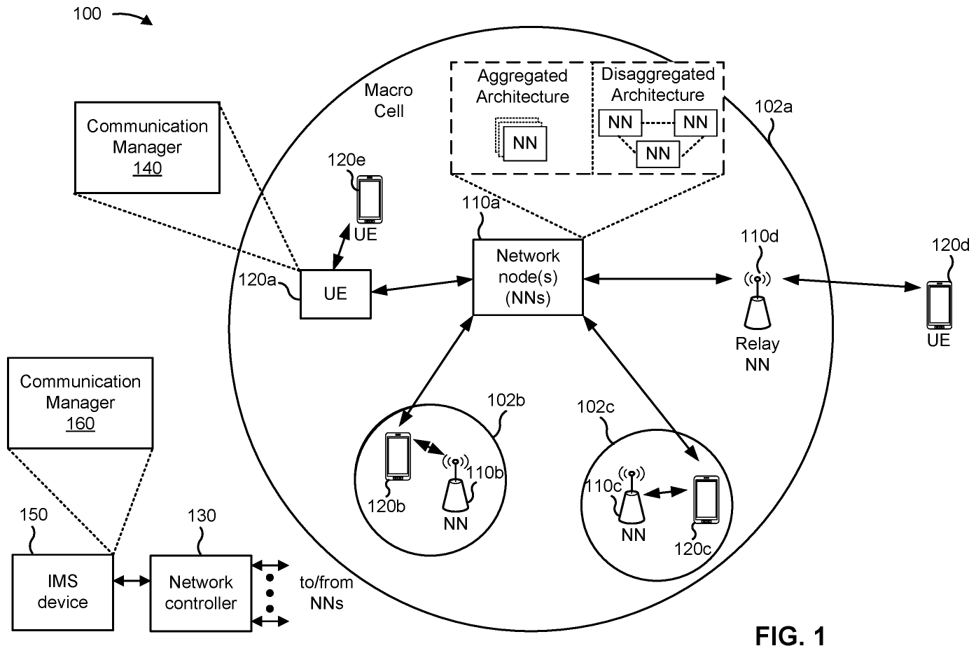

FIG. 1 is a diagram illustrating an example of a wireless network 100, in accordance with the present disclosure. The wireless network 100 may be or may include elements of a 5G (e.g., NR) network and/or a 4G (e.g., LTE) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

In some aspects, the network controller may communicate with an IMS device 150. The IMS device 150 may be a device in an IMS, such as an IMS core network device in an IMS network (e.g., an IMS core network). The IMS may provide various multimedia services to the UEs 120, as described elsewhere herein. The IMS device 150 may include a communication unit (e.g., for communicating with the network controller 130 and/or other network devices), a controller/processor, and a memory, among other examples.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., one or more memories) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, via an access network, an SIP registration message for IMS registration, the SIP registration message including a PANI header that includes at least one of an APN field indicating an APN associated with the access network or an access speed field indicating a data rate associated with the access network; and access one or more IMS services via the access network based at least in part on the SIP registration message. Additionally, or alternatively, the communication manager 140 may perform one or more other operations described herein.

In some aspects, the IMS device 150 may include a communication manager 160. As described in more detail elsewhere herein, the communication manager 160 may receive an SIP registration message for IMS registration associated with a UE, the SIP registration message including a PAN header that includes at least one of an APN field indicating an APN associated with an access network or an access speed field indicating a data rate associated with the access network; and enable one or more IMS services for the UE via the access network based at least in part on the SIP registration message. Additionally, or alternatively, the communication manager 160 may perform one or more other operations described herein.

As indicated above, FIG. 1 is provided as an example. Other examples may differ from what is described with regard to FIG. 1.

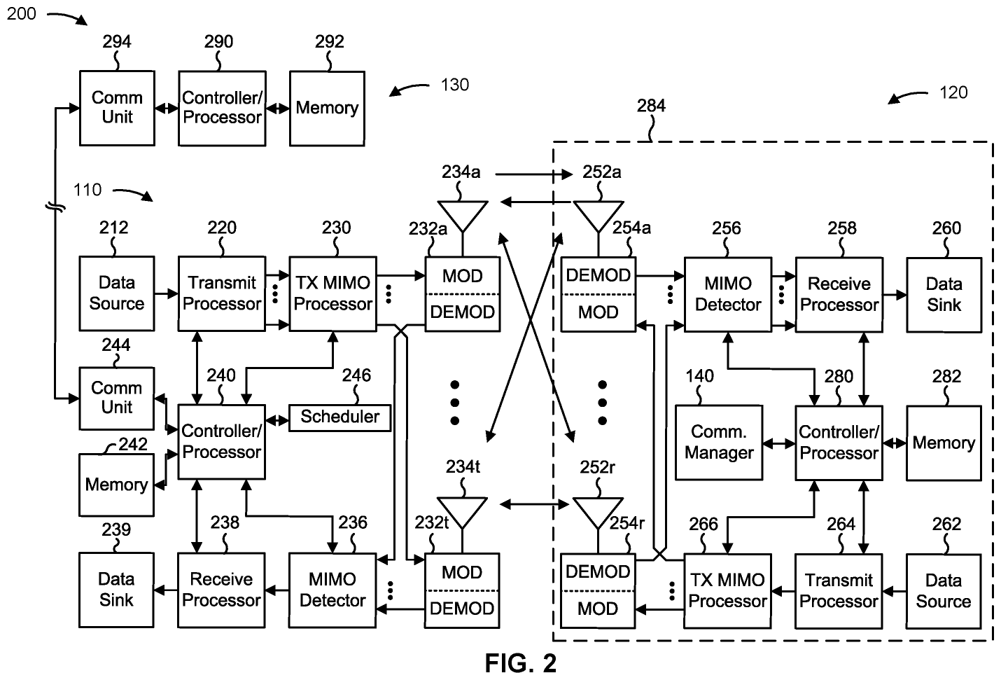

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

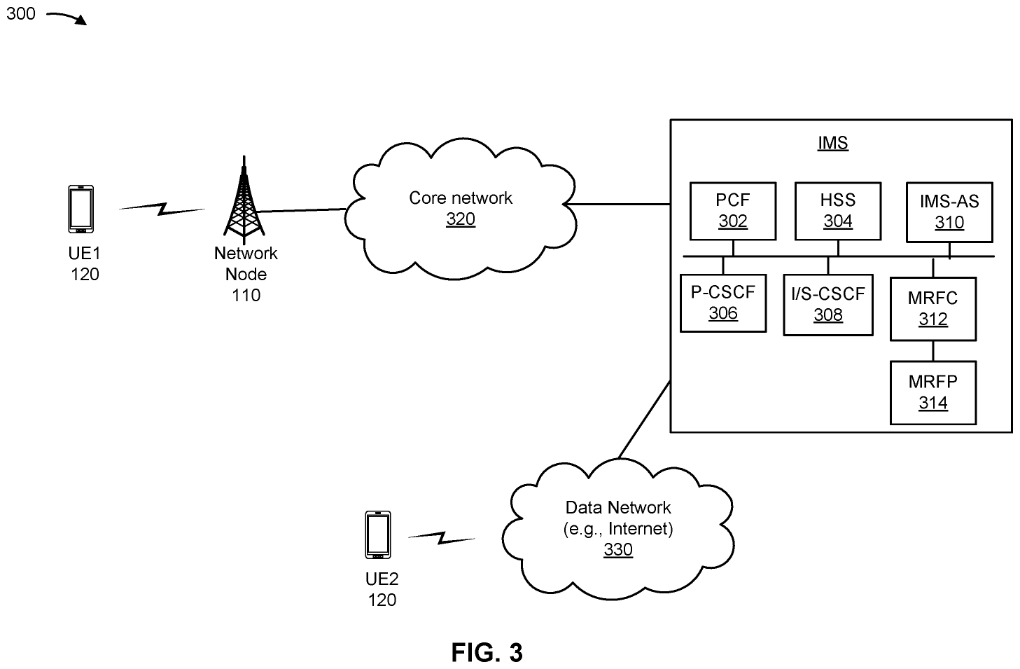

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-8).

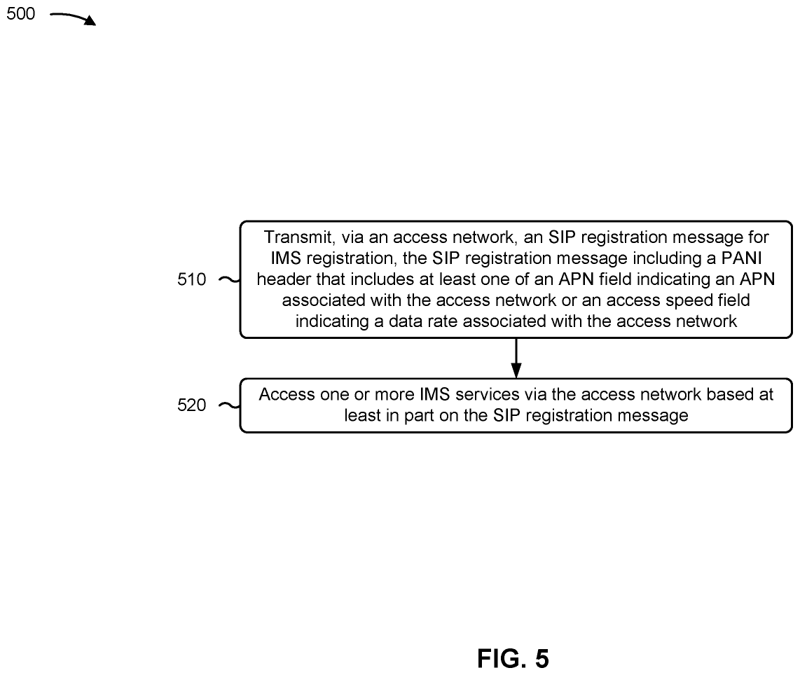

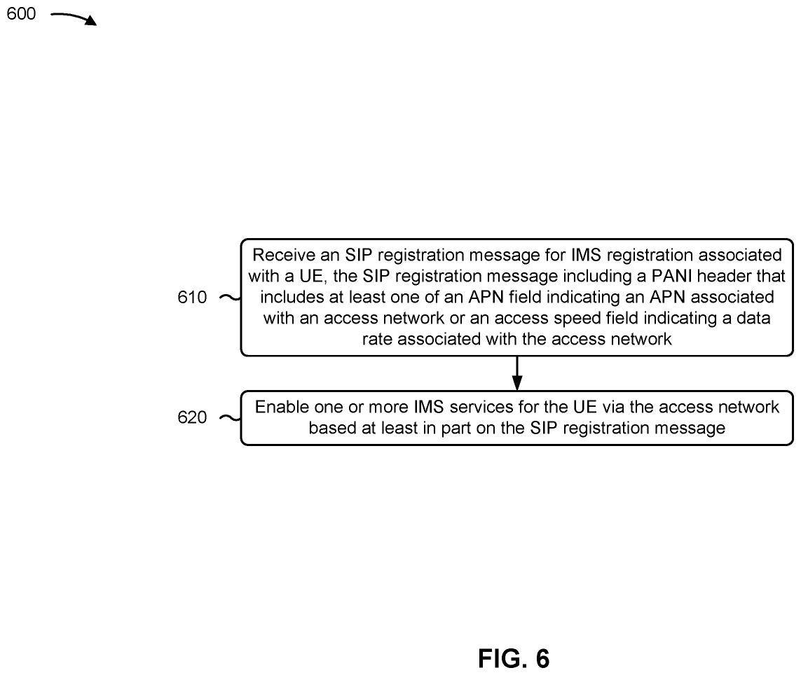

The controller/processor 240 of the network node 110, the controller/processor 280 of the UE 120, and/or any other component(s) of FIG. 2 may perform one or more techniques associated with an enhanced PANI header for IMS voice over internet access, as described in more detail elsewhere herein. For example, the controller/processor 240 of the network node 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, via an access network, an SIP registration message for IMS registration, the SIP registration message including a PANI header that includes at least one of an APN field indicating an APN associated with the access network or an access speed field indicating a data rate associated with the access network; and/or means for accessing one or more IMS services via the access network based at least in part on the SIP registration message. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an IMS device (e.g., the IMS device 150) includes means for receiving an SIP registration message for IMS registration associated with a UE, the SIP registration message including a PANI header that includes at least one of an APN field indicating an APN associated with an access network or an access speed field indicating a data rate associated with the access network; and/or means for enabling one or more IMS services for the UE via the access network based at least in part on the SIP registration message. In some aspects, the means for the IMS to perform operations described herein may include, for example, one or more of communication manager 160, a communication unit, a controller/processor, or a memory.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of IMS communications, in accordance with the present disclosure.

As shown in FIG. 3, the IMS may include a policy control function (PCF) 302, a home subscriber service (HSS) 304, a proxy-call session control function (CSCF) (P-CSCF) 306, an interrogating/serving (I/S)-CSCF 308, an IMS-application server (IMS-AS) 310, a media resource function controller (MRFC) 312, and a media resource function processor (MRFP) 314. The IMS may be or may include an IMS network including one or more IMS devices (e.g., IMS device 150). For example, the components of the IMS shown in FIG. 3 may be implemented in an IMS network and/or on one or more IMS devices (e.g., IMS device 150).

The PCF 302 may facilitate access to a wireless telecommunications network by the IMS and may manage network policy compliance associated with the interface between the wireless telecommunications network and the IMS. The HSS 304 may maintain and manage an IMS user profile associated with a UE (UE 120). The P-CSCF 306 is an SIP proxy that may provide an interface between the IMS and a UE (e.g., the UE 102 and/or 104). The P-CSCF provides subscriber authentication and may establish security protocols with respect to the IMS. The I/S-CSCF 308 may include an interrogation function that queries the HSS 304 to obtain an address for a serving CSCF function of the I/S-CSCF 308 and may assign the address to a UE registering with the IMS. The serving CSCF function of the I/S-CSCF 308 is a SIP server and also may perform session control. The serving CSCF function of the I/S-CSCF 308 may facilitate managing SIP registrations, provide routing and enforce IMS and/or network policies.

The IMS-AS 310 hosts and executes IMS services. The IMS-AS 310 may interface with the I/S-CSCF 308 using SIP. The MRFC 312 and the MRFP 314 form a media resource function (MRF) that provides media functions such as media manipulation, video and audio mixing, and/or other application-based media services. The MRFC 312 is a signaling plane IMS node that may interpret information received from the IMS-AS 310 and/or the I/S-CSCF 308 to control the MRFP 314. The MRFP 314 is a media plane IMS node that may be used to source, combine, and/or otherwise process media streams.

UEs 120 may communicate with the IMS to access IMS services offered by the IMS via different access networks. As shown in FIG. 3, a first UE (UE1) 120 may access the IMS services via an LTE or NR IMS PDN. The UE1 120 may communicate with the IMS via a network node 110 (e.g., a 5G/NR network node or a 4G/LTE network node) and a core network 320. For example, the core network 320 may be a 5G core network (5GC) or 4G evolved packet core (EPC), among other examples. The core network 320 may communicate with the IMS (e.g., the IMS network) via a PDN gateway (PDN-GW) of the core network 320. In some examples, the core network 320 may be associated with a same operator as the IMS. For example, the core network 320 may be a 4G or 5G core network associated with a wireless service provider and the IMS may provide multimedia services offered by that wireless service provider. In this case, a UE that is a subscriber with the wireless service provider may access the IMS services provided by the IMS via the core network 320 when connected to a “home network” to which the UE is subscribed.

As further shown in FIG. 3, a second UE (UE2) 120 may access the IMS services via a data network 330 (e.g., the Internet) other than the LTE/NR IMS PDN. The UE2 may access the data network 330 (e.g., the Internet) via an access point, and the UE2 may communicate with the IMS using an ePDG tunnel over the data network 330 (e.g., the Internet). In some examples, the UE2 may access the IMS services via a cellular internet (CIWLAN) access network. For example, the UE2 may be a subscriber with the wireless service provider that is the operator of the IMS, and the UE2 120 may access the IMS services via a cellular internet access network when the UE2 120 cannot connect via the “home network” (e.g., the 4G/5G IMS PDN) associated with the IMS (e.g., when the UE2 120 is “roaming”). In some examples, the UE2 may access the IMS services via a Wi-fi internet access network, via a non-terrestrial network (NTN) internet access network, or via another internet access network.

As indicated above, FIG. 3 is provided as an example. Other examples may differ from what is described with respect to FIG. 3.

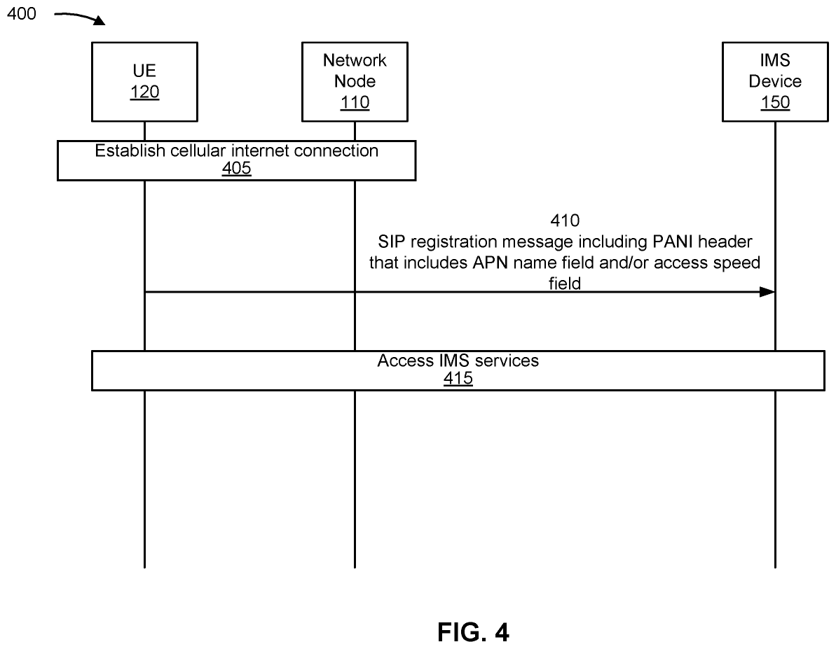

FIG. 4 is a diagram illustrating an example 400 associated with an enhanced PANI header for IMS voice over internet access, in accordance with the present disclosure. As shown in FIG. 4, example 400 includes communication between a UE 120, a network node 110, and an IMS device 150. In some aspects, the operations of the IMS device 150 described herein may be performed by one or more different IMS devices in the IMS network. In some aspects, the IMS device 150 may perform operations associated with one or more of the IMS components described in connection with FIG. 3.

As shown in FIG. 4, and by reference number 405, the UE 120 may communicate with the network node 110 to establish a cellular internet connection. In some aspects, the UE 120 may establish a cellular connection with the network node 110, and the UE 120 may connect to the Internet via the cellular connection. For example, the UE 120 may establish a CIWLAN internet connection. In some examples, the UE 120 may establish the cellular internet (e.g., CIWLAN) connection via a cellular network other than a “home” cellular network associated with an IMS to which a user of the UE 120 is subscribed. In some other aspects, the UE 120 may establish another type of internet connection. For example, the UE 120 may establish a Wi-Fi internet connection or an NTN internet connection, among other examples. In some other aspects, the UE 120 may establish a cellular connection to an LTE/NR IMS PDN associated with the IMS (e.g., the home cellular network associated with the IMS to which the user associated with the UE 120 is subscribed).

As further shown in FIG. 4, and by reference number 410, the UE 120 may transmit, via an access network, a SIP registration message including a PANI header that includes at least one of an APN field and/or an access speed field. The SIP registration message may be for IMS registration (e.g., registration to access IMS services) for the UE 120. The IMS device 150 may receive the SIP registration message transmitted by the UE 120 via the access network. In some aspects, such as shown in example 400, the access network may be a cellular internet (e.g., CIWLAN) access network. In other aspects, the access network may be another type of internet access network (e.g., a Wi-Fi internet access network or NTN internet access network, among other examples) or an IMS PDN (e.g., a LTE/NR PDN associated with the IMS).

In some aspects, the PANI header of the SIP registration message may include the APN field. The APN field may indicate an APN associated with the access network. The APN may identify the access network (e.g., PDN) that is being used by the UE 120 to access the IMS. In some aspects, in a case in which the access network is a cellular internet (e.g., CIWLAN) access network, the PANI header may include at least an access type field and the APN field. In this case, the access type field may indicate a cellular access type for the cellular internet access network. For example, in the case of the cellular internet access network, the UE 120 may set the access type field to “3GPP-EUTRA-FDD” (e.g., for 4G/LTE based cellular internet) or “3GPP-NR-FDD” (e.g., for 5G/NR based cellular internet) or any other cellular access type defined in a wireless communication standard (e.g., defined in section 24.229 of the 3GPP specification). In some aspects, the UE 120 may include the APN field in the PANI header based at least in part on the access type field indicating the cellular access type. For example, the UE 120 may use the APN field to transmit information about the underlying APN used when the access type is set to “3GPP-EUTRA-FDD” or “3GPP-NR-FDD” or any other cellular access type defined in a wireless communication standard (e.g., defined in section 24.229 of the 3GPP specification).

In some aspects, the PANI header of the SIP registration message may include the access speed field. The access speed field may indicate a data rate associated with the access network. For example, the access speed field may indicate an average data rate for the UE 120 on the access network (e.g., the average data rate experienced by the UE 120 using the underling cellular internet (or other access network)). In some aspects, the access speed field may be included in the PANI header (e.g., together with the access type field and the APN field) in cases in which the access network is a cellular internet (e.g., CIWLAN) access network. In some aspects, the access speed field may be included in the PANI header for all types of internet access networks, including cellular internet access networks (e.g., cellular internet connections), Wi-fi internet connection access network (e.g., Wi-fi internet connections), NTN internet access networks (e.g., NTN internet connections), internet access networks via unknown internet connections, and other types of internet access networks. The average data rate may be based at least in part on measurements performed by the UE 120 and/or information received from the network, among other examples.

The UE 120 may monitor the data rate (e.g., the average data rate) associated with the access network. In some aspects, after transmitting the SIP registration message including the access speed field, the UE 120 may determine whether a difference between an updated data rate and the data rate indicated in the PANI header of the SIP registration message satisfies (e.g., is greater than) a threshold. Based at least in part on a determination that the difference between the updated data rate and the data rate indicated in the PANI header of the SIP registration message satisfies (e.g., is greater than) the threshold, the UE 120 may transmit, via the access network, another SIP registration message for IMS re-registration, and the SIP message for IMS re-registration may include a PANI header that indicates the updated data rate in the access speed field. That is, when the UE 120 determines that the data rate has changed by more than the threshold, the UE 120 may perform an IMS reregistration procedure to inform the IMS about the update data rate. The IMS device 150 may receive the SIP registration message including the PANI header that indicates the updated data rate in the access speed field.

In some aspects, in the case in which the access network is a cellular internet (e.g., CIWLAN) access network, the UE 120 may include, in the PANI header, the access type field, the APN field, and the access speed field. In some aspects, in the case in which the access network is a cellular internet (e.g., CIWLAN) access network, the UE 120 may not include, in the PANI header a country code field (e.g., country-code), or any other SIP fields, that explicitly indicate location information associated with the UE 120. For example, such location information may be redundant in the case of a cellular internet access network, because the cellular network may already be aware of the location of the UE 120.

In some examples, a conventional PANI header in a SIP message over CIWLAN (e.g., a cellular internet access network) may be populated as P-Access-Network-Info: IEEE-802.11;i-wlan-node-id=000000000000;country-code=US. That is, the conventional PANI header may incorrectly identify the access type as Wi-fi (e.g., IEEE-802.11) even though the access network is a cellular internet access network. In some aspects, in a case in which the access network is a 5G cellular internet (CIWLAN) access network, the PANI header discussed in connection with FIG. 4 in a SIP message over CIWLAN may be populated (by the UE 120) as P-Access-Network-Info: 3GPP-NR-FDD; access-apn=vzwinternet;access-speed=1 gbps. In this case, the access type is correctly identified, as well as the underlying APN, and the average data date (e.g., 1 bps) is indicated in the PANI header.

As further shown in FIG. 4, and by reference number 415, the UE 120 may access IMS services, via the access network (e.g., the cellular internet access network), based at least in part on the SIP registration message. The IMS device 150 may register the UE 120 with the IMS and enable IMS services for the UE 120 based at least in part on receiving the SIP registration message. In some examples, the IMS device 150 may enable the UE 120 to access certain IMS services based at least in part on the access type, the APN, and/or the access speed indicated in the PANI header of the SIP registration message. In some examples, the IMS device 150 may enable certain QoS levels for IMS services based at least in part on the access type, the APN, and/or the access speed indicated in the PANI header of the SIP registration message. In some aspects, the IMS device 150 may enable different IMS services and/or QoS levels for the UE 120 based at least in part on the PANI header correctly distinguishing between a cellular internet access network and a Wi-fi access network.

In some aspects, the UE 120 may access the IMS services using an ePDG tunnel over the access network (e.g., over the cellular internet access network). In some aspects, the UE 120 may communicate an IMS voice call over the cellular internet access network. For example, the UE 120 may initiate an IMS voice call with another UE over the cellular internet access network (e.g., the UE 120 may transmit a mobile originated (MO) SIP invite message via the IMS) and/or the UE 120 may receive an IMS voice call from another UE over the cellular internet access network (e.g., the UE 120 may receive a mobile terminated (MT) SIP invite message via the IMS). The IMS device 150 may enable the UE 120 to communicate the IMS voice call over the cellular internet access network. For example, the IMS device 150 may receive the MO SIP invite message from the UE 120 and/or the IMS device 150 may transmit the MT SIP message to the UE 120. In some aspects, after the successful IMS registration with the PANI header, the UE 120 may include the PANI header (e.g., the PANI header including the APN field and/or the access speed field) in one or more other SIP messages. For example, after the successful IMS registration with the PANI header, the enhanced PANI header described herein (e.g., the PANI header including the APN field and/or the access speed field) may be used in all further SIP messages in which a PANI header is to be included.

In some aspects, the PANI header including the APN field and/or the access speed field may be included in one or more SIP messages, other than the SIP registration message, used by the UE 120 to access the IMS services provided by the IMS. For example, the UE 120 may include the PANI header including the APN field and/or the access speed field in a SIP invite message or one or more other SIP messages associated with an IMS service.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 120) performs operations associated with an enhanced PANI header for IMS voice over internet access.

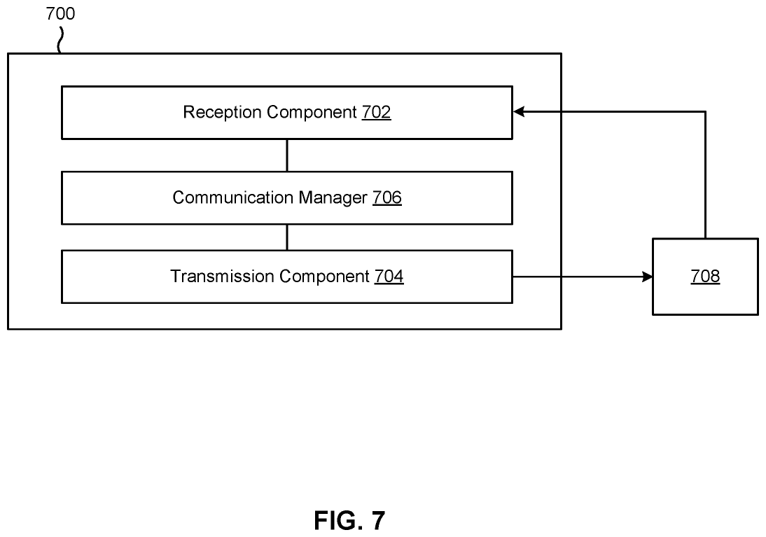

As shown in FIG. 5, in some aspects, process 500 may include transmitting, via an access network, an SIP registration message for IMS registration, the SIP registration message including a PANI header that includes at least one of an APN field indicating an APN associated with the access network or an access speed field indicating a data rate associated with the access network (block 510). For example, the UE (e.g., using transmission component 704 and/or communication manager 706, depicted in FIG. 7) may transmit, via an access network, an SIP registration message for IMS registration, the SIP registration message including a PANI header that includes at least one of an APN field indicating an APN associated with the access network or an access speed field indicating a data rate associated with the access network, as described above.

As further shown in FIG. 5, in some aspects, process 500 may include accessing one or more IMS services via the access network based at least in part on the SIP registration message (block 520). For example, the UE (e.g., using communication manager 706, depicted in FIG. 7) may access one or more IMS services via the access network based at least in part on the SIP registration message, as described above.

Process 500 may include additional aspects, such as any single aspect or any combination of aspects described below and/or in connection with one or more other processes described elsewhere herein.

In a first aspect, the PANI header includes the APN field and the access speed field.

In a second aspect, alone or in combination with the first aspect, the access network is a cellular internet access network.

In a third aspect, alone or in combination with one or more of the first and second aspects, the PANI header further includes an access type field, and the access type field indicates a cellular access type.

In a fourth aspect, alone or in combination with one or more of the first through third aspects, the PANI header includes the APN field based at least in part on the access type field indicating the cellular access type.

In a fifth aspect, alone or in combination with one or more of the first through fourth aspects, the PANI header includes the access type field and the APN field, and the PANI header does not include a country code field.

In a sixth aspect, alone or in combination with one or more of the first through fifth aspects, the PANI header includes the access type field, the APN field, and the access speed field.

In a seventh aspect, alone or in combination with one or more of the first through sixth aspects, accessing the one or more IMS services via the access network comprises communicating an IMS voice call via the cellular internet access network.

In an eighth aspect, alone or in combination with one or more of the first through seventh aspects, the access speed field indicates an average data rate for the UE on the access network.

In a ninth aspect, alone or in combination with one or more of the first through eighth aspects, the PANI header includes the access speed field, and process 500 includes transmitting, based at least in part on determining that a difference between an updated data rate and the data rate indicated in the PANI header satisfies a threshold, another SIP registration message for IMS re-registration, the other SIP registration message including an updated PANI header indicating the updated data rate.

In a tenth aspect, alone or in combination with one or more of the first through ninth aspects, the access network is a cellular internet access network, an NTN internet access network, or another internet access network, and the PANI header includes the access speed field.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by an IMS device, in accordance with the present disclosure. Example process 600 is an example where the IMS device (e.g., IMS device 150) performs operations associated with an enhanced PANI header for IMS voice over internet access.

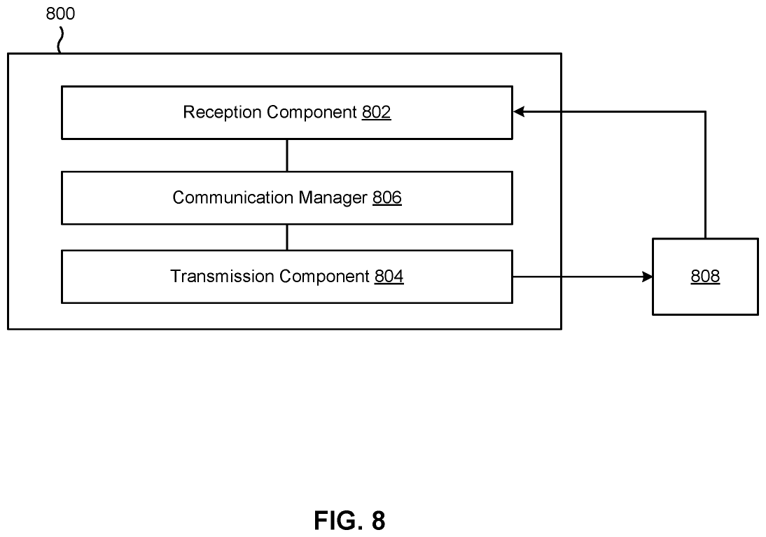

As shown in FIG. 6, in some aspects, process 600 may include receiving an SIP registration message for IMS registration associated with a UE, the SIP registration message including a PANI header that includes at least one of an APN field indicating an APN associated with an access network or an access speed field indicating a data rate associated with the access network (block 610). For example, the IMS device (e.g., using reception component 802 and/or communication manager 806, depicted in FIG. 8) may receive an SIP registration message for IMS registration associated with a UE, the SIP registration message including a PANI header that includes at least one of an APN field indicating an APN associated with an access network or an access speed field indicating a data rate associated with the access network, as described above.

As further shown in FIG. 6, in some aspects, process 600 may include enabling one or more IMS services for the UE via the access network based at least in part on the SIP registration message (block 620). For example, the IMS device (e.g., using communication manager 806, depicted in FIG. 8) may enable one or more IMS services for the UE via the access network based at least in part on the SIP registration message, as described above.

Process 600 may include additional aspects, such as any single aspect or any combination of aspects described below and/or in connection with one or more other processes described elsewhere herein.

In a first aspect, the PANI header includes the APN field and the access speed field.

In a second aspect, alone or in combination with the first aspect, the access network is a cellular internet access network.

In a third aspect, alone or in combination with one or more of the first and second aspects, the PANI header further includes an access type field, and the access type field indicates a cellular access type.

In a fourth aspect, alone or in combination with one or more of the first through third aspects, the PANI header includes the APN field based at least in part on the access type field indicating the cellular access type.

In a fifth aspect, alone or in combination with one or more of the first through fourth aspects, the PANI header includes the access type field and the APN field, and the PANI header does not include a country code field.

In a sixth aspect, alone or in combination with one or more of the first through fifth aspects, the PANI header includes the access type field, the APN field, and the access speed field.

In a seventh aspect, alone or in combination with one or more of the first through sixth aspects, enabling the one or more IMS services via the access network comprises enabling an IMS voice call associated with the UE via the cellular internet access network.

In an eighth aspect, alone or in combination with one or more of the first through seventh aspects, the access speed field indicates an average data rate for the UE on the access network.

In a ninth aspect, alone or in combination with one or more of the first through eighth aspects, the PANI header includes the access speed field, and process 600 includes receiving another SIP registration message for IMS re-registration associated with the UE, the other SIP registration message including an updated PANI header indicating an updated data rate.

In a tenth aspect, alone or in combination with one or more of the first through ninth aspects, the access network is a cellular internet access network, an NTN internet access network, or another internet access network, and the PANI header includes the access speed field.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 140 described in connection with FIG. 1. As shown, the apparatus 700 may communicate with another apparatus 708, such as a UE or a network node (such as a CU, a DU, an RU, or a base station), using the reception component 702 and the transmission component 704.

In some aspects, the apparatus 700 may be configured to perform one or more operations described herein in connection with FIGS. 3-4. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The transmission component 704 may transmit, via an access network, an SIP registration message for IMS registration, the SIP registration message including a PANI header that includes at least one of an APN field indicating an APN associated with the access network or an access speed field indicating a data rate associated with the access network. The communication manager 706 may access one or more IMS services via the access network based at least in part on the SIP registration message.

The transmission component 704 may transmit, based at least in part on a determination that a difference between an updated data rate and the data rate indicated in the PANI header satisfies a threshold, another SIP registration message for IMS re-registration, the other SIP registration message including an updated PANI header indicating the updated data rate.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication, in accordance with the present disclosure. The apparatus 800 may be an IMS device, or a IMS device may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 160 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 3-4. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the IMS device described in connection with FIGS. 1-3. Additionally, or alternatively, one or more components shown in FIG. 8 may be implemented within one or more components described in connection with FIGS. 1-3. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the IMS device described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the IMS device described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive an SIP registration message for IMS registration associated with a UE, the SIP registration message including a PANI header that includes at least one of an APN field indicating an APN associated with an access network or an access speed field indicating a data rate associated with the access network. The communication manager 806 may enable one or more IMS services for the UE via the access network based at least in part on the SIP registration message.

The reception component 802 may receive another SIP registration message for IMS re-registration associated with the UE, the other SIP registration message including an updated PANI header indicating an updated data rate.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: transmitting, via an access network, a session initiation protocol (SIP) registration message for internet protocol (IP) multimedia subsystem (IMS) registration, the SIP registration message including a private access network information (PANI) header that includes at least one of an access point name (APN) field indicating an APN associated with the access network or an access speed field indicating a data rate associated with the access network; and accessing one or more IMS services via the access network based at least in part on the SIP registration message.

Aspect 2: The method of Aspect 1, wherein the PANI header includes the APN field and the access speed field.

Aspect 3: The method of any of Aspects 1-2, wherein the access network is a cellular internet access network.

Aspect 4: The method of Aspect 3, wherein the PANI header further includes an access type field, and wherein the access type field indicates a cellular access type.

Aspect 5: The method of Aspect 4, wherein the PANI header includes the APN field based at least in part on the access type field indicating the cellular access type.

Aspect 6: The method of any of Aspects 4-5, wherein the PANI header includes the access type field and the APN field, and wherein the PANI header does not include a country code field.

Aspect 7: The method of any of Aspects 4-6, wherein the PANI header includes the access type field, the APN field, and the access speed field.

Aspect 8: The method of any of Aspects 3-7, wherein accessing the one or more IMS services via the access network comprises: communicating an IMS voice call via the cellular internet access network.

Aspect 9: The method of any of Aspects 1-8, wherein the access speed field indicates an average data rate for the UE on the access network.

Aspect 10: The method of any of Aspects 1-9, wherein the PANI header includes the access speed field, and wherein the method further comprises: transmitting, based at least in part on determining that a difference between an updated data rate and the data rate indicated in the PANI header satisfies a threshold, another SIP registration message for IMS re-registration, the other SIP registration message including an updated PANI header indicating the updated data rate.

Aspect 11: The method of any of Aspects 1-10, wherein the access network is a cellular internet access network, a non-terrestrial network (NTN) internet access network, or another internet access network, and wherein the PANI header includes the access speed field.

Aspect 12: A method of wireless communication performed by an internet protocol multimedia subsystem (IMS) device, comprising: receiving a session initiation protocol (SIP) registration message for IMS registration associated with a user equipment (UE), the SIP registration message including a private access network information (PANI) header that includes at least one of an access point name (APN) field indicating an APN associated with an access network or an access speed field indicating a data rate associated with the access network; and enabling one or more IMS services for the UE via the access network based at least in part on the SIP registration message.

Aspect 13: The method of Aspect 12, wherein the PANI header includes the APN field and the access speed field.

Aspect 14: The method of any of Aspects 12-13, wherein the access network is a cellular internet access network.

Aspect 15: The method of Aspect 14, wherein the PANI header further includes an access type field, and wherein the access type field indicates a cellular access type.

Aspect 16: The method of Aspect 15, wherein the PANI header includes the APN field based at least in part on the access type field indicating the cellular access type.

Aspect 17: The method of any of Aspects 15-16, wherein the PANI header includes the access type field and the APN field, and wherein the PANI header does not include a country code field.

Aspect 18: The method of any of Aspects 15-17, wherein the PANI header includes the access type field, the APN field, and the access speed field.

Aspect 19: The method of any of Aspects 14-18, wherein enabling the one or more IMS services via the access network comprises: enabling an IMS voice call associated with the UE via the cellular internet access network.

Aspect 20: The method of any of Aspects 12-19, wherein the access speed field indicates an average data rate for the UE on the access network.

Aspect 21: The method of any of Aspects 12-20, wherein the PANI header includes the access speed field, and wherein the method further comprises: receiving another SIP registration message for IMS re-registration associated with the UE, the other SIP registration message including an updated PANI header indicating an updated data rate.

Aspect 22: The method of any of Aspects 12-21, wherein the access network is a cellular internet access network, a non-terrestrial network (NTN) internet access network, or another internet access network, and wherein the PANI header includes the access speed field.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising one or more memories and one or more processors coupled to the one or more memories, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
transmit, via an access network, a session initiation protocol (SIP) registration message for internet protocol (IP) multimedia subsystem (IMS) registration, the SIP registration message including a private access network information (PANI) header that includes at least one of an access point name (APN) field indicating an APN associated with the access network or an access speed field indicating a data rate associated with the access network; and
access one or more IMS services via the access network based at least in part on the SIP registration message.

2. The UE of claim 1, wherein the PANI header includes the APN field and the access speed field.

3. The UE of claim 1, wherein the access network is a cellular internet access network.

4. The UE of claim 3, wherein the PANI header further includes an access type field, and wherein the access type field indicates a cellular access type.

5. The UE of claim 4, wherein the PANI header includes the APN field based at least in part on the access type field indicating the cellular access type.

6. The UE of claim 4, wherein the PANI header includes the access type field and the APN field, and wherein the PANI header does not include a country code field.

7. The UE of claim 4, wherein the PANI header includes the access type field, the APN field, and the access speed field.

8. The UE of claim 3, wherein the one or more processors, to access the one or more IMS services via the access network, are configured to:
communicate an IMS voice call via the cellular internet access network.

9. The UE of claim 1, wherein the access speed field indicates an average data rate for the UE on the access network.

10. The UE of claim 1, wherein the PANI header includes the access speed field, and wherein the one or more processors are further configured to:
transmit, based at least in part on a determination that a difference between an updated data rate and the data rate indicated in the PANI header satisfies a threshold, another SIP registration message for IMS re-registration, the other SIP registration message including an updated PANI header indicating the updated data rate.

11. The UE of claim 1, wherein the access network is a cellular internet access network, a non-terrestrial network (NTN) internet access network, or another internet access network, and wherein the PANI header includes the access speed field.

12. An internet protocol multimedia subsystem (IMS) device for wireless communication, comprising:
one or more memories; and
one or more processors, coupled to the one or more memories, configured to:
receive a session initiation protocol (SIP) registration message for IMS registration associated with a user equipment (UE), the SIP registration message including a private access network information (PANI) header that includes at least one of an access point name (APN) field indicating an APN associated with an access network or an access speed field indicating a data rate associated with the access network; and
enable one or more IMS services for the UE via the access network based at least in part on the SIP registration message.

13. The IMS device of claim 12, wherein the PANI header includes the APN field and the access speed field.

14. The IMS device of claim 12, wherein the access network is a cellular internet access network.

15. The IMS device of claim 14, wherein the PANI header further includes an access type field, and wherein the access type field indicates a cellular access type.

16. The IMS device of claim 15, wherein the PANI header includes the access type field and the APN field, and wherein the PANI header does not include a country code field.

17. The IMS device of claim 15, wherein the PANI header includes the access type field, the APN field, and the access speed field.

18. The IMS device of claim 14, wherein the one or more processors, to enable the one or more IMS services via the access network, are configured to:
enable an IMS voice call associated with the UE via the cellular internet access network.

19. The IMS device of claim 12, wherein the access speed field indicates an average data rate for the UE on the access network.

20. The IMS device of claim 12, wherein the PANI header includes the access speed field, and wherein the one or more processors are further configured to:
receive another SIP registration message for IMS re-registration associated with the UE, the other SIP registration message including an updated PANI header indicating an updated data rate.

21. A method of wireless communication performed by a user equipment (UE), comprising:
transmitting, via an access network, a session initiation protocol (SIP) registration message for internet protocol (IP) multimedia subsystem (IMS) registration, the SIP registration message including a private access network information (PANI) header that includes at least one of an access point name (APN) field indicating an APN associated with the access network or an access speed field indicating a data rate associated with the access network; and
accessing one or more IMS services via the access network based at least in part on the SIP registration message.

22. The method of claim 21, wherein the PANI header includes the APN field and the access speed field.

23. The method of claim 21, wherein the access network is a cellular internet access network.

24. The method of claim 23, wherein the PANI header further includes an access type field, and wherein the access type field indicates a cellular access type.

25. The method of claim 24, wherein the PANI header includes the access type field and the APN field, and wherein the PANI header does not include a country code field.

26. The method of claim 24, wherein the PANI header includes the access type field, the APN field, and the access speed field.

27. The method of claim 23, wherein accessing the one or more IMS services via the access network comprises:
communicating an IMS voice call via the cellular internet access network.

28. The method of claim 21, wherein the access speed field indicates an average data rate for the UE on the access network.

29. The method of claim 21, wherein the PANI header includes the access speed field, and wherein the method further comprises:
transmitting, based at least in part on determining that a difference between an updated data rate and the data rate indicated in the PANI header satisfies a threshold, another SIP registration message for IMS re-registration, the other SIP registration message including an updated PANI header indicating the updated data rate.

30. A method of wireless communication performed by an internet protocol multimedia subsystem (IMS) device, comprising:
receiving a session initiation protocol (SIP) registration message for IMS registration associated with a user equipment (UE), the SIP registration message including a private access network information (PANI) header that includes at least one of an access point name (APN) field indicating an APN associated with an access network or an access speed field indicating a data rate associated with the access network; and
enabling one or more IMS services for the UE via the access network based at least in part on the SIP registration message.
